(19) United States
(12) Patent Application Publication
(10) Pub. No.: US 2009/0108061 A1
(43) Pub. Date: Apr. 30, 2009

(54) PAYMENT TERMINAL WITH HYBRID CARD READER

(75) Inventors: Philippe TARTAVULL, Malibu, CA (US); Chris HENRY, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: HYPERCOM CORPORATION, PHOENIX, AZ (US)

(21) Appl. No.: 12/127,671

(22) Filed: May 27, 2008

Related U.S. Application Data
(60) Provisional application No. 60/931,971, filed on May 25, 2007.

(51) Int. Cl. G06Q 40/00

(52) U.S. Cl. 235/380

(57) ABSTRACT

A method of transferring a value to a smart card includes inserting a smart card into a reader and reading data from at least one of a chip located in said smart card and a magnetic stripe located on a surface of the smart card. The method also includes inputting a transaction request for said value, sending said request and said data to a processing center and receiving approval of said request. The method includes transmitting said value to said smart card, receiving by said smart card of said value, and storing said value on a contactless communication portion of said smart card.

### CROSS-REFERENCE TO RELATED APPLICATIONS

This application claims priority to and benefit of U.S. Provisional Application No. 60/931,971, entitled “PAYMENT TERMINAL WITH HYBRID CARD READER” and filed on May 25, 2007.

### FIELD OF INVENTION

The present invention relates, generally, to point of service (“POS”) terminals, and more particularly to payment transaction POS terminals with a card reader.

### BACKGROUND

Point of service (“POS”) terminals enable convenient electronic payment for many products and services. Consumers holding cards associated with a charge, credit, debit, and/or loyalty accounts may pay for a purchase simply by using the card with a POS terminal located at stores, restaurants, and other locations where the products and services are being purchased. During the transaction, the customers card account information must by captured by the POS terminal. This has been traditionally performed by hand entering, or swiping an transaction card that has a magnetic stripe with account and cardholder details encoded. More recent card types include smartcards and contactless smartcards.

However, while the POS terminal may have all, or some of these card reader interfaces, the card holder may not be aware that the card is enabled to use these alternatives, or where the reader for each is located within the payment terminal. In more recent times the use of magnetic cards is being challenged because the cards magnetic stripe may be easily copied, altered or compromised, while a smartcard, whether or a contact or contactless type can not. Accordingly, it is desirable to create a card reader that is capable of some or all of the possible card interface functions within a single location and as a single usage effort on the POS terminal.

### SUMMARY

Accordingly, various embodiments of the present invention provide a method of transferring a value to a smart card. The method includes inserting a smart card into a reader and reading data from at least one of a chip located in said smart card and a magnetic stripe located on a surface of the smart card. The method also includes inputting a transaction request for said value, sending said request and said data to a processing center and receiving approval of said request. The method includes transmitting said value to said smart card, receiving by said smart card of said value, and storing said value on a contactless communication portion of said smart card. In some aspects of the invention, the reader and the transmitter are housed in one device.

In addition, various embodiments of the present invention provide a device for delivering a value to a smart card. The device includes a smart card interface configured to read data from at least one of a chip located on said smart card, a magnetic strip located on said smart card and a contactless interface located on said smart card. The device also includes electronic transaction circuits in communication with the magnetic stripe reader, the electronic transaction circuits are configured to process the data and approve the value to be delivered to the smart card. The device includes a housing containing the electronic transmitter circuits, the housing is either of attached to or integrated with the smart card interface. The device includes a user interface in communication with the electronic transaction circuits, the user interface is configured to enter the value into the electronic transaction circuits. The device also includes a contactless communication device located in the housing, the contactless communication device is configured for communication between the electronic transaction circuits and the smart card, the contactless communication device configured to deliver the value from the electronic transaction circuits to a location on the smart card.

### DRAWINGS

The drawings described herein are for illustration purposes only and are not intended to limit the scope of the present disclosure in any way. The present invention will become more fully understood from the detailed description and the accompanying drawings wherein:

FIG. 1 illustration of a card reader and a smart card according to various embodiments of the present invention;

FIG. 2 is a cross-sectional view along the line 2-2 of FIG. 1 according to various embodiments of the present invention;

FIG. 3 is an illustration depicting a point of sale terminal having a magnetic stripe reader according to various embodiments of the present invention;

FIG. 4 is an illustration depicting a point of sale terminal having a smart card reader according to various embodiments of the present invention.

### DETAILED DESCRIPTION

The following description is merely exemplary in nature and is not intended to limit the present invention or its teachings, applications, or uses thereof. It should be understood that throughout the drawings, corresponding reference numerals indicate like or corresponding parts and features. The description of specific examples indicated in various embodiments and aspects of the present invention are intended for purposes of illustration only and are not intended to limit the scope of the invention disclosed herein. Moreover, recitation of multiple embodiments having stated features is not intended to exclude other embodiments having additional features or other embodiments incorporating different combinations of the stated features.

The detailed description of exemplary embodiments of the invention herein makes reference to the accompanying drawings, which show exemplary embodiments by way of illustration and the best mode. While these exemplary embodiments are described in sufficient detail to enable those skilled in the art to practice the invention, it should be understood that other embodiments may be realized and that logical and mechanical changes may be made without departing from the spirit and scope of the invention.

For the sake of brevity, conventional data networking, application development and other functional aspects of the system (and components of the individual operating components of the system) may not be described in detail herein. It should be noted that many alternative or additional functional relationships or physical connections may be present in a practical system.

A point of sale (“POS”) terminal according to various embodiments of the present invention includes a card reader, a printer, various electronic circuits for processing a financial transaction, a display for presenting and optionally receiving input of transaction information, a keypad including numeric and function keys, and a housing containing the circuits, display and keypad. The card reader may be housed within the POS terminal or as a stand beside attached module. Housed external to the POS terminal. The POS terminal may also be used with a, bar card reader, biometric reader, or other input devices, and thus may provide for a variety of interfaces. Wireless capabilities may also be incorporated into the present invention to promote portability. Other periphery devices for use with the POS terminal may include additional displays, PIN entry pads, alphanumeric keyboards, voice prompt systems, and signature capture devices. The POS terminal may be a stand alone unit or may be integrated into an electronic cash register (“ECR”), vending machine or a self check-out kiosk and the like.

In an exemplary POS transaction, the POS terminal facilitates payments by extracting account information from a user's transaction instrument (e.g., when a user swipes, inserts or waves a credit card in the reader), receiving authentication input, constructing an authorization message, and communicating the authorization message to a host computer to authorize a financial transaction. As used herein, the term “user” includes a consumer, cardholder, merchant, and merchant temporarily in possession of a consumer's transaction card. Cardholder authentication may be accomplished using a PIN number, signature, voice command, biometric input, encrypted transaction instrument data, or any other suitable input. The host computer performs normal authorization procedures and returns one of an authorization and a rejection message. In performing an “on-line” transaction, after the transaction is consummated, the POS terminal communicates the relevant details of the transaction to be stored on the host computer system. While in performing an “off-Line” transaction, the terminal may approve or decline based on tables or card date or other data, and later forward transaction data to the payment manager host computer. At the end of a transaction, the terminal may print a receipt utilizing the printer that is either housed internally within the POS terminal or housed external to the POS terminal. The POS terminal further communicates with the payment manager host computer to reconcile accounts at the end of a predetermined business cycle (e.g., at the end of each day). Communications between the POS terminal and a host computer may be conducted over any suitable network now known or later developed. As used herein, the term “network” shall include any electronic communications means which incorporates both hardware and software components of such. Exemplary networks or communication channels include a telephone network, an extranet, an intranet, Internet, online communications, satellite communications, off-line communications, wireless communications, transponder communications, local area network (LAN), wide area network (WAN), networked or linked devices, and/or any suitable communication or data input modality.

The present invention facilitates a POS terminal that supports card reads by providing a card reader with two or more of the following: magnetic strip, contact smartcard, and contactless smartcard (sometimes referred to as RFID). As magnetic stripe cards have been in use for many years, the technology used to read information from a card that is swiped through a reader is known and well-established. By co locating the contactless reader antenna with the magnetic stripe reader, when a user goes to swipe the card equipped with both magstripe and contactless smartcard, the contactless data shall be read at the same time or before the magnetic stripe. This allows a more secure and trusted transaction

The card reader interface may be in the form of a magnetic reader and contactless reader, located so both read at the same time, or alternatively an insertion reader capable of magnetic stripe, contact smartcard, and contactless smartcard.

Other features of various embodiments of the present invention may include or support electronic signature capture, an interactive screen, multi-tasking capabilities, age and identity verification, program or account enrollment, account status and balance inquiries, payroll and government check reading, and medical or other insurance claim transactions. The present invention may be used with various types of accounts including credit, debit, charge, and loyalty programs and may also accommodate payment by promotion or gift cards, prepaid cards.

The devices and methods of the present invention described herein are useful for either employing a credit card or a debit card, collectively referred to as a transaction card. Generally, the transaction card has at least a magnetic strip on its surface that may be swiped at a POS terminal to complete a transaction for payment for a good or service. The methods of such a transaction are typically within the ISO/IEC 7810 standard which defines the dimensions as 8.560×5.98 millimeters. All standardized dimensions typically have a thickness of 0.76 for a card. Some transaction cards may be imbedded with a hologram to avoid counterfeiting.

A smart card may also be known as a chip card or an integrated circuit card. A smart card is well known in the art and has an imbedded integrated circuit which can process information. A smart card can receive an input which is processed by way of the integrated circuit or chip with an application based on it and then deliver an output. A contact smart card has a contact area comprised of several gold-plated contact pads that is about a centimeter square. When the contact smart card is inserted into a reader that makes contact with electrical connectors that can read information from the chip and write information back. A typical smart card follows the dimensions of ISO/IEC 7810 which determines the dimensions of the card and ISO/IEC 7816 which defines the physical location and electrical characteristics of the chip. Contact smart cards typically do not contain batteries and the energy is supplied by the card reader for functions that are done on the chip. Contact smart cards typically have standard communication protocols so that a smart card may be used in different readers and transactions can be completed. Contact smart cards are used as communication medium between a smart card and a host, and such host may be a computer, a POS terminal, a mobile phone, a transit entry point, a public phone, and the like.

Another type of smart card is known as a contactless smartcard. A contactless smartcard contains a chip that communicates with a card reader through RFID induction technology. A contactless smartcard requires only proximity to an antenna to complete the transaction. A contactless smartcard is typically defined by the dimensions of a standard transaction card, for example, ISO/IEC 7816, and will have a standardized communication protocol, for example as defined by ISO/IEC 1443. Typically, a contactless smartcard may be in communication at distances of up to ten centimeters. A standard for contactless smartcard is ISO/IEC 15693 which allows communication at distances up to 50 centimeters. Other standards may be available at larger distances for applications such as mass transit and toll roads.

A smartcard may have more than one technology on it. For example, a smart card may have a magnetic strip and a chip. A smart card may have a magnetic strip, a chip and a contactless interface all on one card. A smart card may have a chip and a contactless interface on one card. Sometimes a smart card having a magnetic strip and at least a chip may be known as a hybrid smart card. The devices and methods of the present invention described herein are useful with a smart card having a contactless interface and at least one of a chip and a magnetic strip.

Various embodiments of the present invention provide a method of a method of transferring a value to a hybrid smart card. The method includes swiping a magnetic stripe of said smart card across a magnetic reader and reading data from said magnetic stripe. The method also includes inputting a transaction request for said value, sending said request and said data to a processing center and receiving approval of said request. The method includes transmitting said value to said smart card, receiving by said smart card of said value, and storing said value on a portion of said smart card. In some aspects of the invention, the method can include activating a transmitter. The activating of the transmitter can be activated by a second swiping of said magnetic stripe of said smart card across said magnetic reader. In some aspects of the invention, the magnetic reader and the transmitter are housed in one device.

Various embodiments of the present invention provide a method of transferring a value to a smart card. The method includes inserting a smart card into a reader and reading data from a chip located in said smart card. The method also includes inputting a transaction request for said value, sending said request and said data to a processing center and receiving approval of said request. The method includes transmitting said value to said smart card, receiving by said smart card of said value, and storing said value on a contactless communication portion of said smart card. In some aspects of the invention, the method can include activating a transmitter. The activating of the transmitter can be activated by said receiving approval of said request. In some aspects of the present invention, the transmitting the value to the smart card is activated by the receiving approval of the request. In some aspects of the invention, the smart card reader and the transmitter are housed in one device.

Various embodiments of the present invention provide a method of transferring a value to a smart card. The method includes inserting a smart card into a reader and reading data from at least one of a chip located in said smart card and a magnetic stripe located on a surface of the smart card. The method also includes inputting a transaction request for said value, sending said request and said data to a processing center and receiving approval of said request. The method includes transmitting said value to said smart card, receiving by said smart card of said value, and storing said value on a contactless communication portion of said smart card. In some aspects of the invention, the reader and the transmitter are housed in one device.

In various embodiments, the methods can include comprising spending the value using a contactless interface of said portion of said smart card interfaced with a point of sale device of a seller. The seller can be a merchant or an individual. The seller can provide goods or services. The seller can provide virtual products. The seller can provider media services such as for example, iTunes, iCasts, music, movies, videos, and the like. The seller can provide transportation services, such as for example, fees for subways, buses, trains, toll roads, and the like. The seller can provide communication services, such as for example, phone cards, cell service, hot spots, wireless internet, and the like. In various embodiments of the invention the value can be a monetary value and/or at least one loyalty point. In some aspects of the present invention, the methods can include preventing transfer of the data to the point of sale device of the seller. In some aspects of the present invention, the methods can include denying a request to access the data by the point of sale device of the seller.

Various embodiments of the present invention provide a device for delivering a value to a smart card. The device includes a magnetic stripe reader having a track and at least one magnetic reader head located on the track and the magnetic stripe reader configured to read data from a magnetic stripe on the smart card. The device also includes electronic transaction circuits in communication with the magnetic stripe reader, the electronic transaction circuits are configured to process the data and approve the value to be delivered to the smart card. The device includes a housing containing the electronic transmitter circuits, the housing is either of attached to or integrated with the magnetic stripe reader. The device includes a user interface in communication with the electronic transaction circuits, the user interface is configured to enter the value into the electronic transaction circuits. The device also includes a wireless communication device located in the housing, the wireless communication device is configured for communication between the electronic transaction circuits and the smart card, the wireless communication device configured to deliver the value from the electronic transaction circuits to a location on the smart card. In some aspects, the device can include a smart card interface configured to communicate with a chip located on the smart card and read the data from the chip.

Various embodiments of the present invention provide a device for delivering a value to a smart card. The device includes a smart card interface configured to read data from a chip located on said smart card. The device also includes electronic transaction circuits in communication with the magnetic stripe reader, the electronic transaction circuits are configured to process the data and approve the value to be delivered to the smart card. The device includes a housing containing the electronic transmitter circuits, the housing is either of attached to or integrated with the smart card interface. The device includes a user interface in communication with the electronic transaction circuits, the user interface is configured to enter the value into the electronic transaction circuits. The device also includes a contactless communication device located in the housing, the contactless communication device is configured for communication between the electronic transaction circuits and the smart card, the contactless communication device configured to deliver the value from the electronic transaction circuits to a location on the smart card. In some aspects, the smart card interface can also have a magnetic stripe reader configured to read data from a magnetic stripe located on a surface of the smart card.

Various embodiments of the present invention provide a device for delivering a value to a smart card. The device includes a smart card interface configured to read data from at least one of a chip located on said smart card, a magnetic strip located on said smart card and a contactless interface located on said smart card. The device also includes electronic transaction circuits in communication with the magnetic stripe reader, the electronic transaction circuits are configured to process the data and approve the value to be delivered to the smart card. The device includes a housing containing the electronic transmitter circuits, the housing is either of attached to or integrated with the smart card interface. The device includes a user interface in communication with the electronic transaction circuits, the user interface is configured to enter the value into the electronic transaction circuits. The device also includes a contactless communication device located in the housing, the contactless communication device is configured for communication between the electronic transaction circuits and the smart card, the contactless communication device configured to deliver the value from the electronic transaction circuits to a location on the smart card.

In various embodiments of the present invention, a device can include an interface being configured to enter a pass code. The user interface can comprise a keypad and a display. The user interface can be configured to input any user information or data such as a PIN, a zip code, cashback amounts, account type, and the like. In various embodiments, a device can include a network communication interface in communication with the electronic transaction circuits and one of an internet, an intranet, and a telephone line. A device can be a point of sale terminal or a component thereof. A device can include a smart card interface, a contactless antenna circuit reader, a radio frequency receiver, an infrared receiver, a bar code reader, and/or a biometric reader configured for communication with said smart card. In various embodiments of the invention the value delivered by a device can be a monetary value and/or at least one loyalty point.

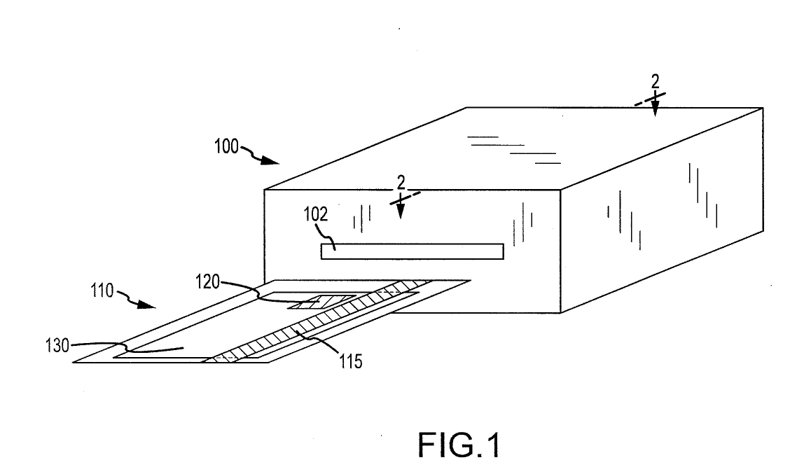

With reference to FIG. 1, card reader 100 is illustrated according to various embodiments of the present invention. Card reader 100 has a slot 102 that is sized for insertion of a smart card 110. Slot 102 may be sized according to ISO standards as described herein and known to those skilled in the art. Smart card 101 typically is sized to ISO standards as described herein. In various embodiments, smart card 101 has a contactless interface 130 and at least one of a chip 120 and a magnetic stripe 115. Contactless interface, chip and magnetic stripe typically are positioned within the standards defined by ISO and described herein. In an aspect of the present invention, smart card 110 comprises a contactless interface 130, chip 120 and magnetic stripe 115. In some aspects of the present invention, smart card 110 comprises contactless interface 130 and chip 120. In some aspects of the present invention, smart card 110 comprises contactless interface 130 and magnetic stripe 115.

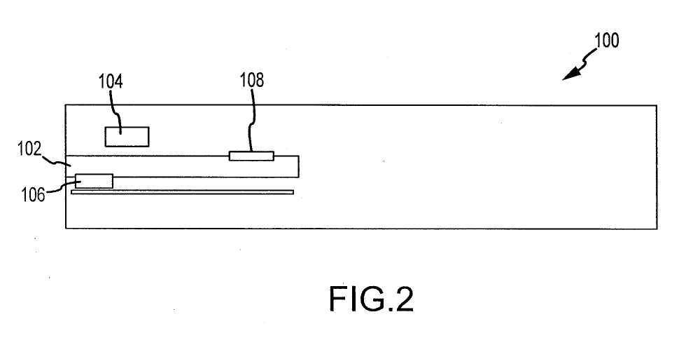

Moving to FIG. 2, cross-sectional view of card reader 100 along the line 2-2 is illustrated according to various embodiments of the present invention. Slot 102 comprises at least one magnetic head 106 and a chip reader 108. Magnetic head 106 and chip reader 108 may be positioned based on the ISO standards or any other industry standard that may be useful. Transceiver 104 includes at least one of a transmitter and a receiver and is employed to contact and receive information from the RFID located in the contactless interface 130 of smart card 110. Card reader 100 may be used to carry out methods of the present invention as described herein. For example, smart card 110 may be inserted into slot 102 and data is read from at least one of chip 120 and magnetic stripe 115. Card reader can be in contact with contactless interface 130 and value may be transferred by reading the data from at least one of chip 120 and magnetic stripe 115 inputting the value and transmitting the value by transceiver 104 to contactless interface 130 and storing the value on smart card 110. Such value may be monetary value, store credit, a gift card, and royalty points, and/or reward points. Other methods of the present invention that may employ reader 100 are described herein.

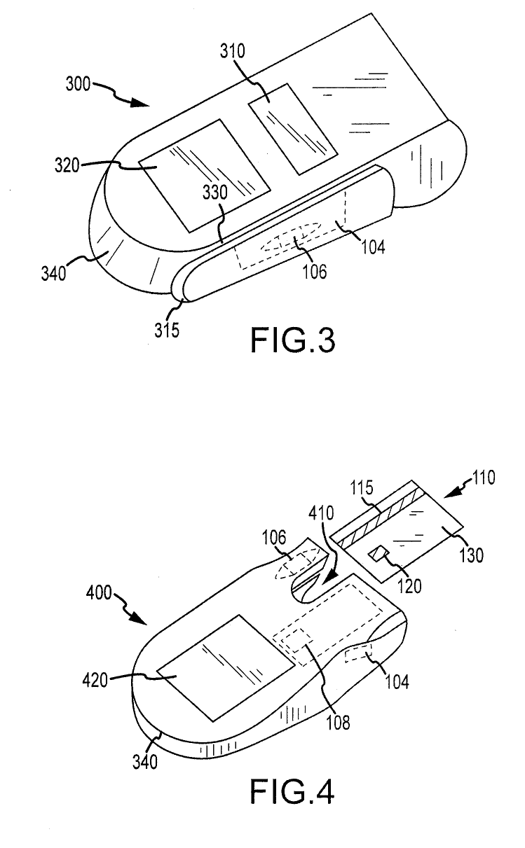

FIG. 3 illustrates a POS terminal according to various embodiments of the present invention. POS terminal 300 includes a housing 304, card reader 315, key pad 320, and interactive display 310. The housing 304 contains electronic transaction circuits and such circuits are in communication with card reader 315, key pad 320, interactive display 310, and communication interface. The electronic transaction circuits can include basic components not shown here, such as a power supply circuit, internal clock, microcontroller or microprocessor, ROM, RAM, lights, and other suitable hardware for communicating with a host computer, and inputting, processing, transferring or displaying transaction data. The communication interface allows the electronic transaction circuits to communication to a service provider via the internet, an intranet, a phone line, a mobile cell connection, a wireless connection, or the like

Card reader 315 comprises track 330, magnetic read head 106 and transceiver 104. Magnetic read head 106 is positioned on track 330 to read magnetic stripe 115 of card 110. The transceiver 104 communicates with the contactless interface 130 of the card 110. The POS 300 is suitable to be employed for the method of the present invention and as described herein.

FIG. 4 illustrates a POS terminal according to various embodiments of the present invention. POS terminal 400 includes a housing 304, smart card reader 410, key pad 320, and interactive touch screen 420. The housing 304 contains electronic transaction circuits and such circuits are in communication with smart card reader 410, interactive touch screen 420, and communication interface. The electronic transaction circuits can include basic components not shown here, such as a power supply circuit, internal clock, microcontroller or microprocessor, ROM, RAM, lights, and other suitable hardware for communicating with a host computer, and inputting, processing, transferring or displaying transaction data. The communication interface allows the electronic transaction circuits to communication to a service provider via the internet, an intranet, a phone line, a mobile cell connection, a wireless connection, or the like.

Card reader 410 comprises, slot 102, magnetic read head 106, chip reader 108, and transceiver 104. Magnetic read head 106 and chip reader 108 are positioned on slot 102 to read magnetic stripe 115 and chip 120 respectively of card 110. The transceiver 104 communicates with the contactless interface 130 of the card 110. POS 400 is suitable to be employed for the method of the present invention and as described herein.

In various embodiments of the invention, a micro-processor disposed in a POS terminal such as for example POS terminal 300 or POS terminal 400 and associated programming modules support simultaneous processing of data in two different software applications or in two separate transactions. This multi-thread or multi-application functionality enables POS terminal users to conduct a second concurrent transaction without having to wait for completion of an earlier submitted transaction. For example, a user may conduct a loyalty program transaction concurrent with a credit card transaction. Such multi-thread processing is advantageous, for example, when a user desires to pay for an item using a mixture of loyalty program points and credit or debit charges. Concurrent transaction processing is similarly advantageous in performing concurrent credits/returns and new purchases, concurrent purchases and loyalty program credits, concurrent age and/or identity verification and check cashing, concurrent purchases and program enrollments, or concurrent purchases and rebate processing. An exemplary POS terminal may also support multiple applications, that is two or more separate applications may exist on the terminal, and may be invoked manually by selection, for example, from a base menu, or automatically based on input card data. In other words, various embodiments of a POS terminal support multiple concurrent applications or transactions, and/or multiple asynchronous applications or transactions invoked either manually or automatically.

The POS terminal facilitates concurrent transactions by establishing multiple communication channels or multiple dialogues over a single channel with distinct applications or systems and by simultaneously communicating or processing transaction information and user inputs to the distinct applications or systems. For example, a combined charge card/loyalty card may include stored data to prompt the POS terminal to communicate transaction information to both the charge account host system and the loyalty program host systems. A user's PIN entry may likewise be submitted to both host systems to provide user authentication. This enables loyalty programs to be more flexible and responsive in offering program benefits to members.

Various embodiments of the invention supports age and identity verification by extracting user data from a user's transaction instrument, requesting authentication input, and verifying the user data and authentication input with user data stored on the host system of the transaction instrument issuer. Age and identity verification may likewise be performed using any appropriate transaction instrument data, host system data or user supplied data.

Various embodiments of the invention support payroll check and government check reading and/or cashing. For example, the POS terminal facilitates the capture of routing and account numbers, and any other relevant information from bar codes or other machine readable indicia printed or otherwise accessible on such checks. Thus, a consumer may present such checks for immediate electronic verification and drawing of funds from the check issuer's account for use in payment at a POS terminal. In embodiments that include a cash return device, a consumer may receive any remaining balance of the check value as cash.

In various embodiments of the invention, IP and/or USB ports enable connectivity of the POS terminal with a keyboard, personal computer, or with additional POS terminals. Additionally, the POS terminal may support both Ethernet and modem connectivity capabilities. Redundant communications connectivity capabilities serve to reduce or eliminate the impact of temporary network failures by automatically reestablishing communications with a host system using a backup communications channel. For example, if a local internet network hub fails, the POS automatically dials the appropriate host system using a back-up modem. Additional wireless communication capabilities enable portable use of the POS terminal. For example, a salesperson may carry a wireless POS terminal on his or her belt for assisting customer's with showroom purchases without the need to relocate to a cashier's desk.

The present invention has been described above with reference to various exemplary embodiments. However, those skilled in the art will recognize that changes and modifications may be made to the exemplary embodiments without departing from the scope of the present invention. For example, the various operational steps, as well as the components for carrying out the operational steps, may be implemented in alternate ways depending upon the particular application or in consideration of any number of cost functions associated with the operation of the system, e.g., various steps may be deleted, modified, or combined with other steps. These and other changes or modifications are intended to be included within the scope of the present invention, as set forth in the following claims.

What is claimed is:

1. A method of transferring a value to a hybrid smart card, the method comprising:
swiping a magnetic stripe of said smart card across a magnetic reader;
reading data from said magnetic stripe;
inputting a transaction request for said value;
sending said request and said data to a processing center;
receiving approval of said request;
transmitting said value to said smart card;
receiving by said smart card of said value; and
storing said value on a portion of said smart card.

2. The method according to claim 1, further comprising activating a transmitter.

3. The method according to claim 2, wherein said activating a transmitter is activated by a second swiping of said magnetic stripe of said smart card across said magnetic reader.

4. The method according to claim 1 further comprising spending said value using a contactless interface of said portion of said smart card interfaced with a point of sale device of a seller.

5. The method according to claim 4, wherein said seller is one of a transportation provider and a media provider.

6. The method according to claim 4, wherein said seller is one of a goods provider and a service provider.

7. The method according to claim 4, further comprising preventing transfer of said data to said point of sale device.

8. The method according to claim 4 further comprising denying a request to access said data by said point of sale device.

9. The method according to claim 1, wherein said value is a monetary value.

10. The method according to claim 1, wherein said value is at least one loyalty point.

11. The method according to claim 1, wherein said magnetic reader and said transmitter are housed in one device.

12. A method of transferring a value to a smart card, the method comprising:
inserting a smart card into a reader;
reading data from a chip located in said smart card;
inputting a transaction request for a value;
sending said request and said data to a processing center;
receiving approval of said request;
transmitting said value to said smart card;
receiving by said smart card of said value; and
storing said value on a contactless communication portion of said smart card.

13. The method according to claim 12, further comprising activating a transmitter.

14. The method according to claim 13, wherein said activating a transmitter is activated by said receiving approval of said request.

15. The method according to claim 12, further comprising spending said value via a contactless interface of said portion of said smart card interfaced with a point of sale device of a seller.

16. The method according to claim 15, wherein said seller is one of a transportation provider, and a media provider.

17. The method according to claim 15, wherein said seller is one of a goods provider and a service provider.

18. The method according to claim 15, further comprising preventing transfer of said data to said point of sale device.

19. The method according to claim 15, further comprising denying a request to access said data by said point of sale device.

20. The method according to claim 16, wherein said reader and said transmitter are housed in one device.

21. The method according to claim 13, wherein said transmitting said value to said smart card is activated by said receiving approval of said request.

22. The method according to claim 13, wherein said value is a monetary value.

23. The method according to claim 12, wherein said value is at least one loyalty point.

24. A method of transferring a value to a smart card, the method comprising:
inserting a smart card into a reader;
reading data from one of a chip located in said smart card and a magnetic stripe located on a surface of said smart card;
inputting a transaction request for a value;
sending said request and said data to a processing center;
receiving approval of said request;
transmitting said value to said smart card;
receiving by said smart card of said value; and
storing said value on a contactless communication portion of said smart card

25. A method according to claim 24, comprising activating a transmitter.

26. A device for delivering a value to a smart card, the device comprising:
a magnetic stripe reader having a track and at least one magnetic reader head located on said track, said magnetic stripe reader configured to read data from a magnetic stripe on said smart card;
electronic transaction circuits in communication with said magnetic stripe reader, said electronic transaction circuits configured to process said data and approve said value to be delivered;
a housing containing said electronic transmitter circuits, said housing is at least one of attached to and integrated with said magnetic stripe reader;
a user interface in communication with said electronic transaction circuits, said user interface configured to enter said value into said electronic transaction circuits; and
a wireless communication device located in said housing, said wireless communication device configured for communication between said electronic transaction circuits and said smart card, said wireless communication device configured to deliver said value from said electronic transaction circuits to a location on said smart card.

27. The device according to claim 26 wherein said user interface is configured to enter a pass code.

28. The device according to claim 26 wherein said user interface comprise a keypad and a display.

29. The device according to claim 26 further comprising a smart card interface configured to communicate with a chip located on said smart card and read said data from said chip.

30. The device according to claim 26 further comprising network communication interface in communication with said electronic transaction circuits and one of an internet, an intranet, and a telephone line.

31. The device according to claim 26 further comprising a point of sale terminal.

32. The device according to claim 26 further comprising at least one of a smart card interface, a contactless antenna circuit reader, a radio frequency receiver, an infrared receiver, a bar code reader, and a biometric reader configured for communication with said smart card.

33. The device according to claim 26 wherein said value is a monetary value.

34. The device according to claim 26 wherein said value is at least one loyalty point.

35. A device for delivering a value to a smart card, the device comprising:
a smart card interface configured to read data from a chip located on said smart card;
electronic transaction circuits in communication with said smart card interface, said electronic transaction circuits configured to process said data and approve said value to be delivered;
a housing containing said electronic transaction circuits, said housing is at least one of attached to and integrated with said smart card interface;
a user interface in communication with said electronic transaction circuits, said user interface configured to enter said value into said electronic transaction circuits; and
a contactless communication device located in said housing, said contactless communication device configured for communication between said electronic transaction circuits and said smart card, said contactless communication device configured to deliver said value from said electronic transaction circuits to a location on said smart card.

36. The device according to claim 35 wherein said smart card interface comprising a magnetic stripe reader configured to read data from a magnetic stripe located on a surface of said smart card.

37. The device according to claim 35 wherein said user interface is configured to enter a pass code.

38. The device according to claim 35 wherein said user interface comprise a keypad and a display.

39. The device according to claim 35 further comprising network communication interface in communication with said electronic transaction circuits and one of an internet, an intranet, and a telephone line.

40. The device according to claim 35 further comprising a point of sale terminal.

41. The device according to claim 35 further comprising at least one of a smart card interface, a contactless antenna circuit reader, a radio frequency receiver, an infrared receiver, a bar code reader, and a biometric reader configured for communication with said smart card.

42. The device according to claim 35 wherein said value is a monetary value.

43. The device according to claim 35 wherein said value is at least one loyalty point.

44. A device for delivering a value to a smart card, the device comprising:
a smart card interface configured to read data from at least one of a chip located on said smart card, a magnetic strip located on said smart card and a contactless interface located on said smart card;
electronic transaction circuits in communication with said smart card interface, said electronic transaction circuits configured to process said data and approve said value to be delivered;
a housing containing said electronic transaction circuits, said housing is at least one of attached to and integrated with said smart card interface;
a user interface in communication with said electronic transaction circuits, said user interface configured to enter said value into said electronic transaction circuits; and
a contactless communication device located in said housing, said contactless communication device configured for communication between said electronic transaction circuits and said smart card, said contactless communication device configured to deliver said value from said electronic transaction circuits to a location on said smart card.
